(19) United States
(12) Patent Application Publication
(10) Pub. No.: US 2006/0279693 A1
(43) Pub. Date: Dec. 14, 2006

(54) Pair of eyeglasses with two lens units pivotable between two temples

(76) Inventor: Yung-Ming Huang, Taipei Hsien (TW)

Correspondence Address: LADAS & PARRY, 5670 WILSHIRE BOULEVARD, SUITE 2100, LOS ANGELES, CA, 90036-5679, US

(21) Appl. No.: 11/150,797

(22) Filed: Jun. 10, 2005

(51) Int. Cl. G02C 1/02

(52) U.S. Cl. 351/110

(57) ABSTRACT

A pair of eyeglasses includes two temples, two lens units, two swing members interconnected fixedly by a bridge body, and a nose support unit connected pivotally to the bridge body. Each of the temples has a front end with a fixed hinge. The swing members are connected respectively and fixedly to outer sides of the lens units. Each of the swing members has a pivot portion extending forwardly therefrom and connected pivotally to a corresponding one of the hinges. The lens units are rotatable relative to the temples and the nose support unit about an axis.

### BACKGROUND OF THE INVENTION

1.

Field of the Invention

This invention relates to eyeglasses, and more particularly to a pair of eyeglasses that includes two lens units, which are pivotable between two temples.

2. Description of the Related Art

Referring to FIG. 1, a conventional eyeglass assembly 90 includes an auxiliary eyeglass unit 91 and a full-lens frame primary eyeglass unit 92. The auxiliary eyeglass unit 91 is connected pivotally to the primary eyeglass unit 92, and is pivotable between first and second positions. When the auxiliary eyeglass unit 91 is disposed at the first position, the wearer can see clearly a nearby object. When the auxiliary eyeglass unit 91 is disposed at the second position, the wearer can see clearly a distant object. Although the conventional eyeglass assembly 90 is convenient to use, it is heavy.

To reduce the weight of such an eyeglass assembly, the full-lens frame primary eyeglass unit 92 may be replaced with a half-lens frame primary eyeglass unit 93. With this structure, however, the total weight of the auxiliary eyeglass unit 91 and the half-lens frame primary eyeglass unit 93 is still burdensome to the wearer.

### SUMMARY OF THE INVENTION

The object of this invention is to provide a pair of eyeglasses that includes two lens units, each of which is pivotable between two temples to a generally horizontal position so as to be removed from the line of vision of the wearer.

According to this invention, a pair of eyeglasses comprises:

two temples, each of which includes a temple body having a front end, and a hinge disposed fixedly on and behind the front end of the temple body;

two lens units each having opposite inner and outer sides;

two swing members disposed respectively and fixedly on the outer sides of the lens units and disposed respectively behind the hinges of the temples, each of the swing members having a pivot portion that extends forwardly therefrom and that is connected pivotally to the hinge of a respective one of the temples, the pivot portions of the swing members being rotatable about an axis; and

a bridge unit including a bridge body interconnecting fixedly the inner sides of the lens units and formed with a fixed hinge, and a nose support unit having a pivot portion that is connected pivotally to the hinge of the bridge body and that is rotatable about the axis.

### BRIEF DESCRIPTION OF THE DRAWINGS

These and other features and advantages of this invention will become apparent in the following detailed description of the preferred embodiments of this invention, with reference to the accompanying drawings, in which:

FIG. 1 is a fragmentary schematic side view of a conventional eyeglass assembly;

FIG. 2 is a fragmentary schematic side view of another conventional eyeglass assembly;

FIG. 3 is a fragmentary, partly sectional top view of the first preferred embodiment of a pair of eyeglasses according to this invention;

FIG. 4 is an exploded perspective view illustrating a connection between a temple and a swing member of the first preferred embodiment;

FIG. 5 is an exploded perspective view illustrating a connection between a nose support unit and a bridge portion of the first preferred embodiment;

FIG. 6 is a fragmentary, partly sectional side view of the first preferred embodiment, illustrating positions of two lens units relative to two temples;

FIG. 7 is a fragmentary, partly sectional side view of the first preferred embodiment, illustrating how the lens units are pivotable forwardly relative to the temples to generally horizontal positions;

FIG. 8 is a fragmentary, partly sectional side view of the first preferred embodiment, illustrating positions of the lens units relative to a nose support unit;

FIG. 9 is a fragmentary, partly sectional side view of the first preferred embodiment, illustrating how the lens units are pivotable forwardly relative to the nose support unit to the generally horizontal position;

FIG. 10 is a fragmentary top view of the first embodiment when the lens units are disposed at the generally horizontal positions;

FIG. 11 is a fragmentary, partly sectional top view of the second preferred embodiment of a pair of eyeglasses according to this invention;

FIG. 12 is a front view of the third preferred embodiment of a pair of eyeglasses according to this invention;

FIG. 13 is a fragmentary, partly sectional top view of the third preferred embodiment;

FIG. 14 is a fragmentary, partly sectional top view of the fourth preferred embodiment of a pair of eyeglasses according to this invention;

FIG. 15 is a fragmentary, partly sectional top view of the fifth preferred embodiment of a pair of eyeglasses according to this invention;

FIG. 16 is a front view of the fifth preferred embodiment;

FIG. 17 is a fragmentary, partly sectional top view of the sixth preferred embodiment of a pair of eyeglasses according to this invention; and

FIG. 18 is a partly sectional view illustrating a modified nose support unit.

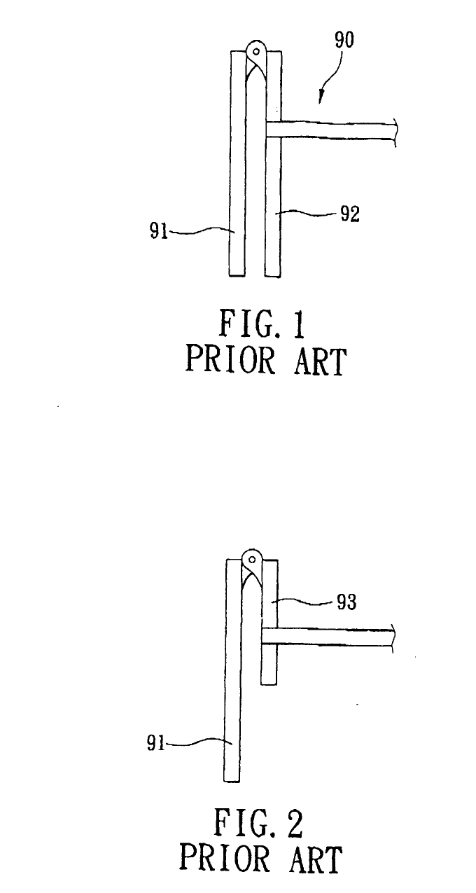

### DETAILED DESCRIPTION OF THE PREFERRED EMBODIMENTS

Before the present invention is described in greater detail in connection with the preferred embodiments, it should be noted that similar elements and structures are designated by like reference numerals throughout the entire disclosure.

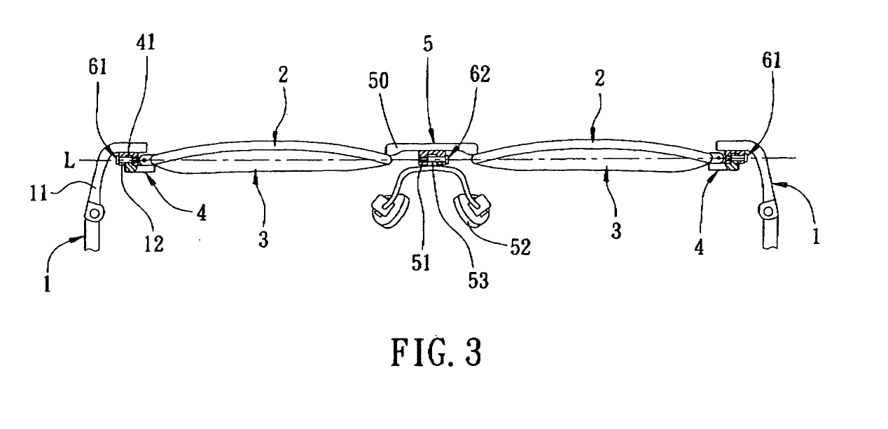

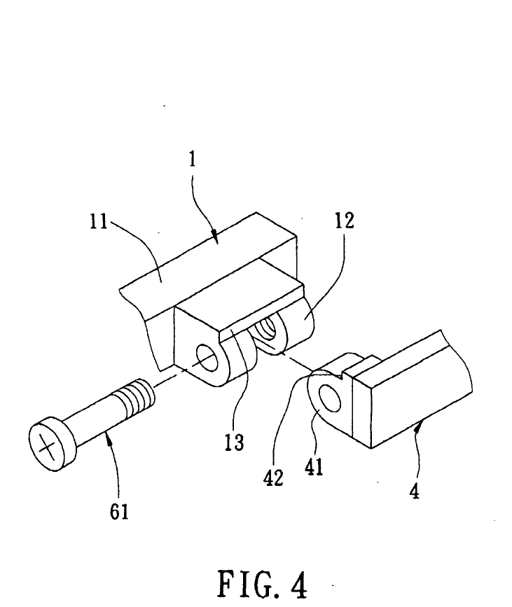

Referring to FIGS. 3 and 4, the first preferred embodiment of a pair of eyeglasses according to this invention includes two temples 1, two lens units each consisting of an annular lens frame 2 and a lens 3, two swing members 4, a bridge unit 5, two side pivot bolts 61, and a middle pivot bolt 62.

Referring to FIGS. 3, 4 and 6, each of the temples 1 includes a temple body 11, and a hinge 12 formed integrally with and disposed behind a front end of the temple body 11. Each of the hinges 12 has a stop portion 13 at an upper end thereof. The lenses 3 are fitted respectively and securely within the lens frames 2.

The swing members 4 are disposed respectively and fixedly on outer sides of the lens frames 2, and are located respectively behind the hinges 12 of the temples 1. Each of the swing members 4 has a pivot portion 41 that extends forwardly therefrom and that is connected pivotally to the hinge 12 of the corresponding temple 1 by a side pivot bolt 61. The pivot portions 41 of the swing members 4 are rotatable about an axis (L). Each of the swing members 4 is formed with an integral projection 42 disposed above the corresponding pivot portion 41. The projections 42 of the swing members 4 abut respectively against the stop portions 13 of the hinges 12 of the temples 1. This prevents rearward pivoting of lower ends of the lenses 3 relative to the temples 1, while allowing for forward pivoting of the lower ends of the lenses 3 relative to the temples 1, as shown in FIG. 7.

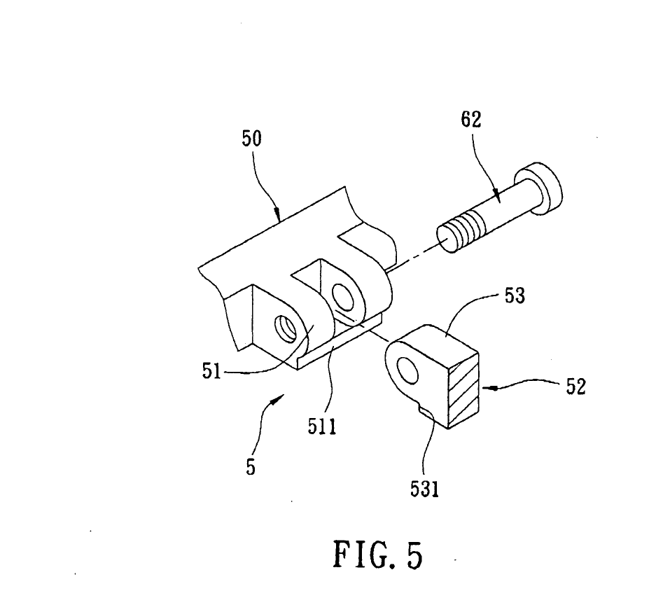

Referring to FIGS. 3, 5 and 8, the bridge unit 5 includes a bridge body 50 interconnecting fixedly inner sides of the lens frames 2 and formed with an integral hinge 51, and a nose support unit 52 attached to the bridge body 50. The nose support unit 52 has a pivot portion 53 that is connected pivotally to the hinge 51 of the bridge body 50 by a middle pivot bolt 62 and that is rotatable about the axis (L). The hinge 51 has a stop portion 511 at a lower end thereof. The nose support unit 52 is formed with an integral projection 531 disposed under the pivot portion 53. The projection 531 of the nose support unit 52 abuts against the stop portion 511 of the hinge 51 of the bridge body 50. This prevents rearward pivoting of the lower ends of the lenses 3 relative to the nose support unit 52, while allowing for forward pivoting of the lower ends of the lenses 3 relative to the nose support unit 52, as shown in FIG. 9.

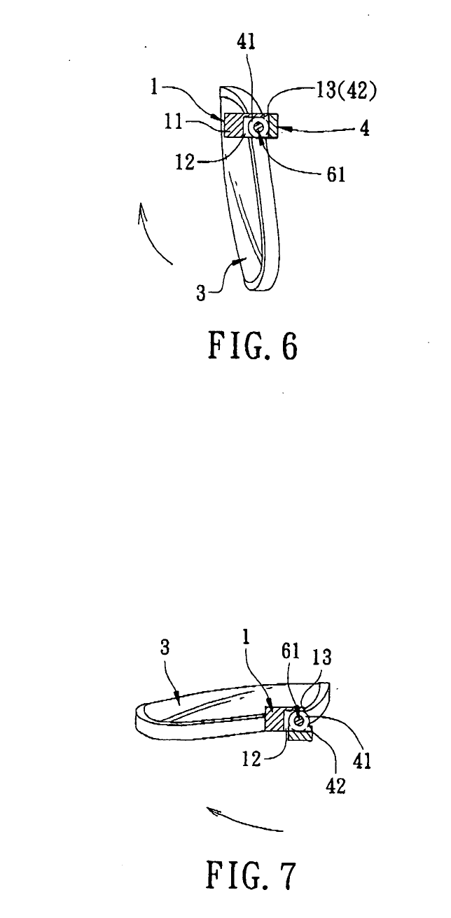

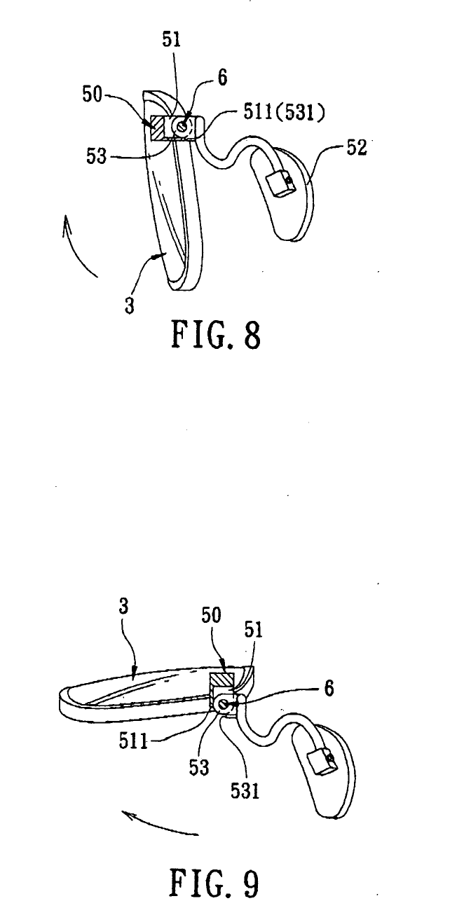

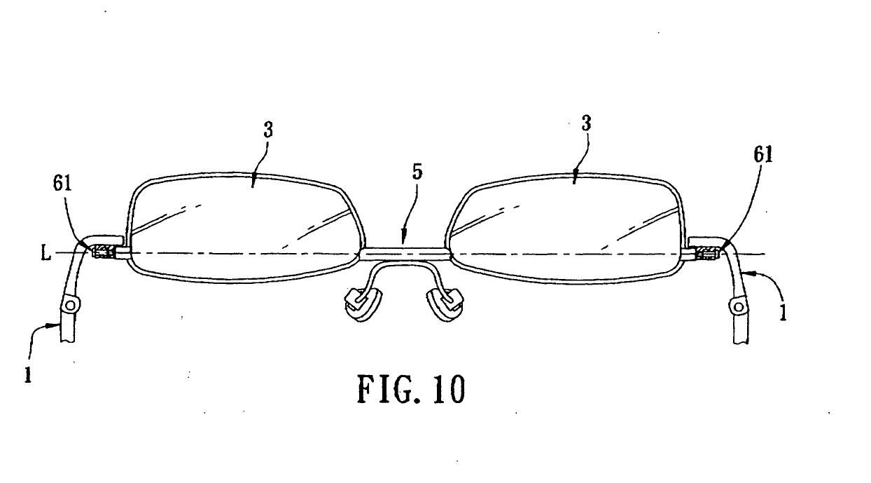

During normal use, each of the lenses 3 is in an upright position in a conventional manner, as shown in FIGS. 6 and 8. Referring to FIGS. 7 and 9, when use of the lenses 3 is not needed, the lenses 3 are pivoted forwardly relative to the temples 1 and the nose support unit 52 to generally horizontal positions. This latter positioning is also shown in FIG. 10.

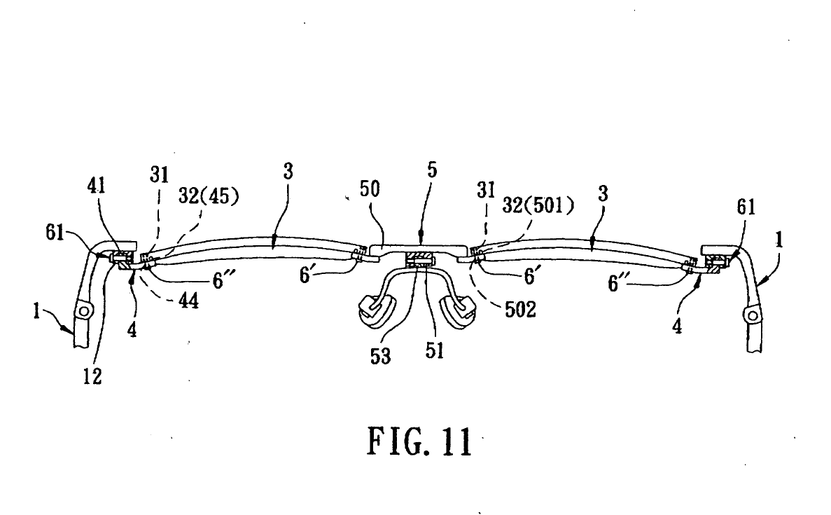

FIG. 11 shows the second preferred embodiment of a pair of eyeglasses according to this invention. In contrast to the first preferred embodiment, each of the lens units in this embodiment is frameless, and includes a lens 3 that has opposite inner and outer sides, each of which is formed with a threaded hole 31 and a groove 32. The bridge body 50 has two opposite ends, each of which is formed with a tongue 501 and a hole 502. Each of the swing members 4 is also formed with a hole 44 and a tongue 45. The tongues 501, 45 of the bridge body so and the swing members 4 engage respectively and fittingly the grooves 32 in the inner and outer sides of the lenses 3. Two headed inner bolts 6′ extend respectively through the holes 502 in the bridge body 50 to engage respectively the threaded holes 31 in the inner sides of the lenses 3. Two headed outer bolts 6″ extend respectively through the holes 44 in the swing members 4 to engage respectively the threaded holes 31 in the outer sides of the lenses 3. Thus, the bridge portion 50 and the swing members 4 are connected fixedly to the lenses 3.

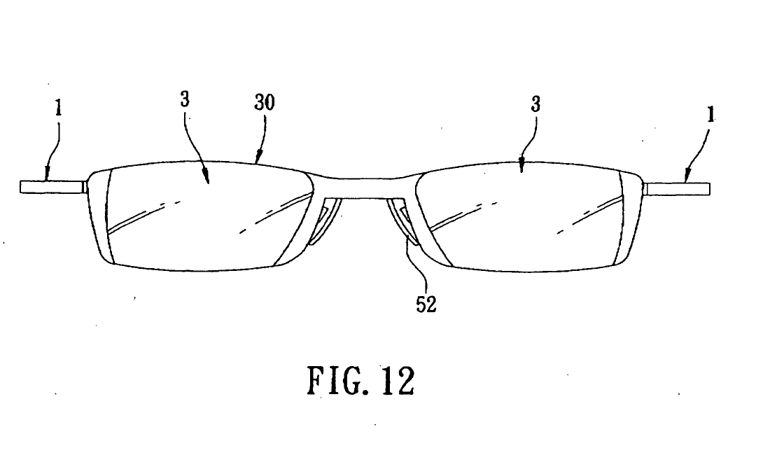

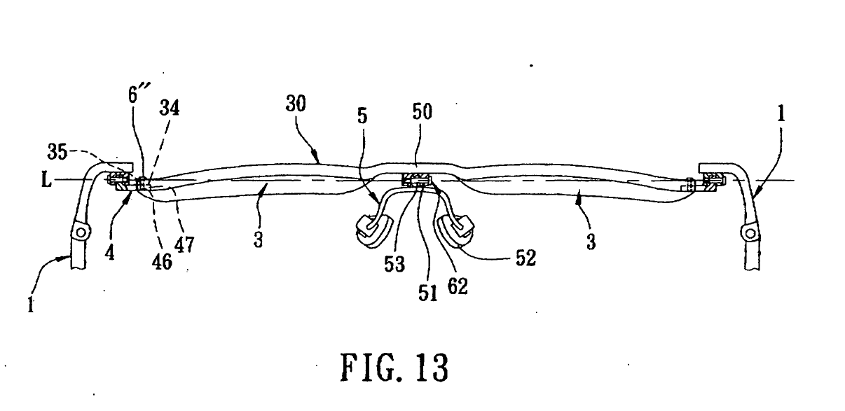

FIGS. 12 and 13 show the third preferred embodiment of a pair of eyeglasses according to this invention. In contrast to the first preferred embodiment, each of the lens units in this embodiment includes a lens 3 formed integrally with the bridge body 50 of the bridge unit 5 and having an outer side that is formed with a recess 34 and a hole 35, which are communicated with each other. Each of the swing members 4 has an inner end that engages fittingly the recess 34 in the corresponding lens 3 and that is formed with a threaded hole 46. Two headed bolts 6″ extend respectively through the holes 35 in the lenses 3 to engage respectively the threaded holes 46 in the swing members 4 Thus, the swing members 4 are connected respectively and fixedly to the lenses 3.

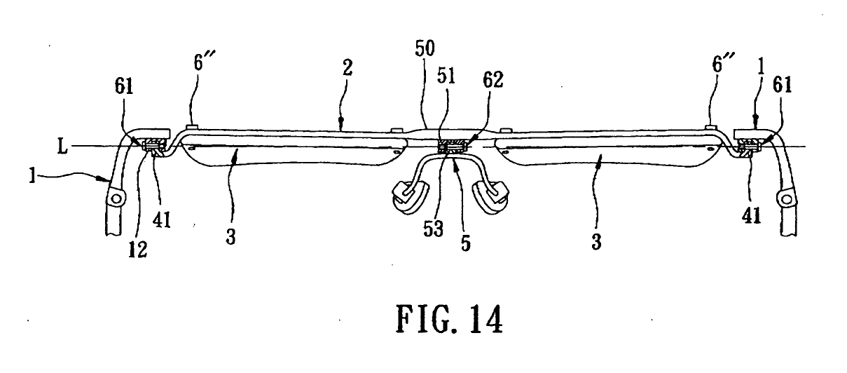

FIG. 14 shows the fourth preferred embodiment of a pair of eyeglasses according to this invention. In contrast to the first preferred embodiment, each of the lens units in this embodiment includes an annular lens frame 2 formed integrally with the bridge body 50, and a lens 3 connected threadedly to a rear surface of the annular lens frame 2. The lens frames 2 and the lenses 3 are generally planar.

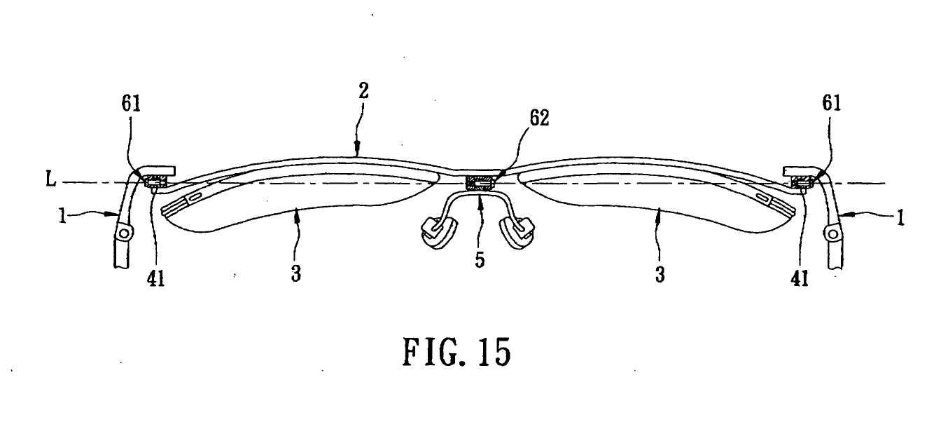

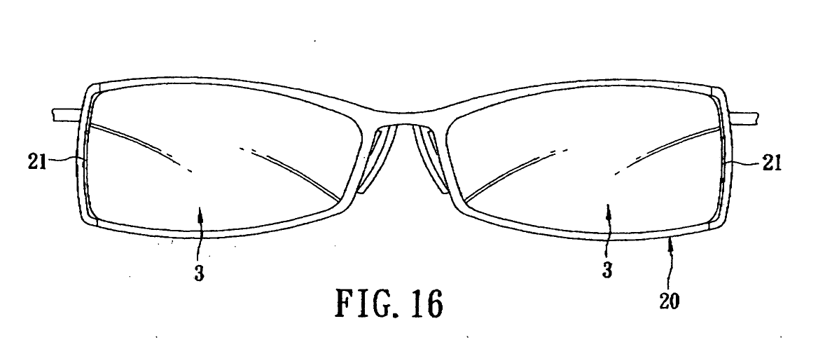

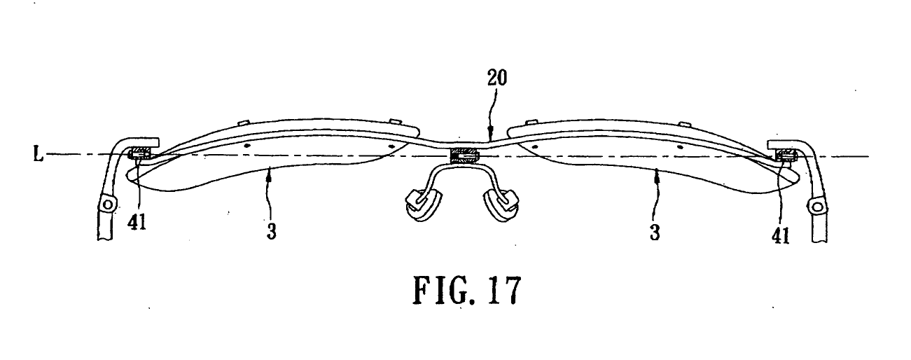

FIGS. 15 and 16 show a modification of the lens units of the fourth preferred embodiment. In contrast to the fourth preferred embodiment, the lens frames 2 and the lenses 3 are curved, and the outer sides of the lens frame 2 and the lens 3 of each of the lens units are spaced apart from each other. The lenses 3 are disposed entirely behind the lens frames 2. Alternatively, the lenses 3 may be disposed partially in front of the lens frames 2, as shown in FIG. 17.

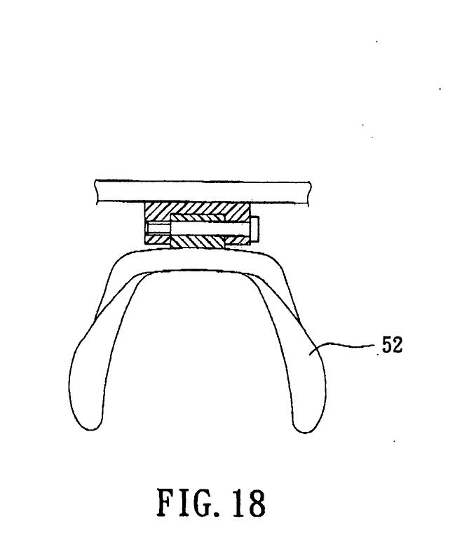

Referring to FIG. 18, the nose support unit 52 may be injection molded.

With this invention thus explained, it is apparent that numerous modifications and variations can be made without departing from the scope and spirit of this invention. It is therefore intended that this invention be limited only as indicated by the appended claims.

I claim:

1. A pair of eyeglasses comprising:
two temples, each of which includes a temple body having a front end, and a hinge disposed fixedly on and behind said front end of said temple body;
two lens units each having opposite inner and outer sides;
two swing members disposed respectively and fixedly on said outer sides of said lens units and disposed respectively behind said hinges of said temples, each of said swing members having a pivot portion that extends forwardly therefrom and that is connected pivotally to said hinge of a respective one of said temples, said pivot portions of said swing members being rotatable about an axis; and
a bridge unit including a bridge body interconnecting fixedly said inner sides of said lens units and formed with a fixed hinge, and a nose support unit having a pivot portion that is connected pivotally to said hinge of said bridge body and that is rotatable about said axis.

2. The pair of eyeglasses as claimed in claim 1, wherein said hinge of each of said temples has a stop portion at an upper end thereof, each of said swing members being formed with a projection, said projections of said swing members being disposed respectively above said pivot portions of said swing members, said projections of said swing members abutting respectively against said stop portions of said hinges of said temples so as to prevent rearward pivoting of lower ends of said lens units relative to said temples while allowing for forward pivoting of said lower ends of said lens units relative to said temples.

3. The pair of eyeglasses as claimed in claim 2, wherein said hinge of said bridge body of said bridge unit has a stop portion at a lower end thereof, said nose support unit being formed with a projection disposed under said pivot portion of said nose support unit, said projection of said nose support unit abutting against said stop portion of said hinge of said bridge body of said bridge unit so as to prevent rearward pivoting of said lower ends of said lens units relative to said nose support unit while allowing for forward pivoting of said lower ends of said lens units relative to said nose support unit.

4. The pair of eyeglasses as claimed in claim 1, further comprising two side pivot bolts extending respectively through said hinges of said temples and through said pivot portions of said swing members, and a middle pivot bolt extending through said hinge of said bridge body and said pivot portion of said nose support unit so as to connect said pivot portions of said swing members respectively and pivotally to said hinges or said temples and so as to connect said pivot portion of said nose support unit pivotally to said hinge of said bridge body.

5. The pair of eyeglasses as claimed in claim 1, wherein each of said lens units includes an annular lens frame and a lens fitted securely within said annular lens frame.

6. The pair of eyeglasses as claimed in claim 1, wherein each of said lens units is frameless, and includes a lens that has opposite inner and outer sides, each of which is formed with a threaded hole and a groove, each of two opposite ends of said bridge body being formed with a hole and a tongue, each of said swing members also being formed with a hole and tongue, said tongues of said bridge body and said swing members engaging respectively and fittingly said grooves in said inner and outer sides of said lenses, said eyeglasses further comprising two headed inner bolts extending respectively through said holes in said bridge body to engage respectively said threaded holes in said inner sides of said lenses, and two headed outer bolts extending respectively through said holes in said swing members to engage respectively said threaded holes in said outer sides of said lenses, whereby said bridge portion and said swing members are connected fixedly to said lenses.

7. The pair of eyeglasses as claimed in claim 1, wherein each of said lens units includes a lens formed integrally with said bridge body of said bridge unit and having an outer side that is formed with a recess and a hole, which are communicated with each other, each of said swing members having an inner end that engages fittingly said recess in a respective one of said lenses and that is formed with a threaded hole, said eyeglasses further comprising two headed bolts that extend respectively through said holes in said lenses to engage respectively said threaded holes in said swing members so as to connect said swing members respectively and fixedly to said lenses.

8. The pair of eyeglasses as claimed in claim 1, wherein each of said lens units includes an annular lens frame having a rear surface, and a lens connected threadedly to said rear surface of said annular lens frame, said bridge body of said bridge unit being formed integrally with said annular lens frames.
